(19) United States
(12) Patent Application Publication
(10) Pub. No.: US 2024/0029149 A1
(43) Pub. Date: Jan. 25, 2024

(54) ESTIMATING MARKET RENT VALUE OF A PROPERTY

(71) Applicant: Offerland Technologies Inc., Vancouver (CA)

(72) Inventors: Amir Abdi, Vancouver (CA); James Adinata, Vancouver (CA); Hamidreza Etebarian, Vancouver (CA); Raz Seyednejad, Vancouver (CA); Masoud Sadri, Vancouver (CA)

(73) Assignee: Offerland Technologies Inc., Vancouver, BC (CA)

(21) Appl. No.: 18/223,502

(22) Filed: Jul. 18, 2023

Related U.S. Application Data
(60) Provisional application No. 63/390,608, filed on Jul. 19, 2022.

(51) Int. Cl. G06Q 30/0645; G06Q 50/16

(52) U.S. Cl. CPC G06Q 30/0645; G06Q 50/163

(57) ABSTRACT

The present disclosure relates to a method for estimating a final rent estimate (FRE) of a property. The method enables receiving, at a computing device, a dwelling input from a user. A remote server acquires the received dwelling input from the computing device and analyses a property database to determine an initial rent estimate (IRE) based on each property located in a geological grid and each adjacent geological grid. The server identifies the multiple comparable properties based on the determined IRE, acquired dwelling input and at least one filter, which can be selected from a spatial filter, a temporal filter, a configuration filter and a variance filter. The FRE can be calculated based on the rental value of the identified multiple comparable properties, wherein a rental value contribution of each comparable property is inversely proportional to a distance from the location input. The calculated FRE is displayed at the computing device.

### TECHNICAL FIELD

The present invention pertains to the field of real estate market analytics, specifically to a system and method employing machine learning techniques for estimating a final rent estimate (FRE) of a property.

### BACKGROUND

Determining market rent value of a property, either for residential or commercial purposes, has been a challenging task for potential tenants, property owners, real estate appraisers, lenders and financial institutions. These individuals often rely on basic market research, their personal experience, or the advice of professionals to arrive at an estimated value. In addition, the current approaches primarily rely on human intervention and subjective judgement, which can be susceptible to errors, bias, and inconsistencies. This can be particularly problematic for users who do not have extensive knowledge or experience in real estate markets.

Additionally, existing methods of property rental estimation often lack the ability to consider multiple factors simultaneously and objectively. This can lead to significant discrepancies between the estimated value and actual market value. Moreover, the existing systems typically do not allow real-time updates and adjustments based on current market trends and conditions.

Furthermore, traditional methods of property rent estimation do not allow for easy customization and adjustment according to the specific needs and preferences of user. This inflexibility leads to a lack of optimal options and results for users with unique requirements or circumstances.

Current systems also lack an efficient and convenient means of presenting and sharing the information generated. This can hinder users' ability to make informed decisions and share their findings with others, thereby decreasing the utility and effectiveness of these systems.

The advent of cloud technology has significantly improved the scope of data handling and processing capabilities. The ability to store and access vast amounts of data remotely has opened up new opportunities for improving property rent estimation systems. However, the potential of this technology has not been fully exploited in the context of property rent estimation.

The recent developments in machine learning and data processing techniques also provide new avenues for improving property rent estimation systems. However, these techniques have not been fully integrated into such systems to optimize their efficiency and accuracy.

In light of the above, there is a need for a cloud-based system that utilizes the potential of modern technology to offer an accurate, efficient, and flexible solution for property rent estimation. The proposed system, which is capable of receiving user inputs, leveraging a property database, and applying data analysis techniques, aims to address these needs. Consequently, there exists a need for a system that can provide an objective and accurate estimation of property rental value without necessitating human intervention.

The system presents a range of estimated values, generates lists of comparable properties, calculates a data confidence score, offers exporting features, displays property and neighbourhood details, and incorporates machine learning techniques, offers a significant improvement over existing solutions. By addressing the shortcomings of existing systems, the proposed disclosure aims to transform the way users estimate property rental values and make informed decisions.

All references, including publications, patent applications, and patents, cited herein are hereby incorporated by reference to the same extent as if each reference were individually and specifically indicated to be incorporated by reference and were set forth in its entirety herein.

It also shall be noted that as used herein and in the appended claims, the singular forms “a” “an”, and “the” include plural referents unless the context clearly dictates otherwise. This invention can be achieved by means of hardware including several different elements or by means of a suitably programmed computer. In the unit claims that list several means, several ones among these means can be specifically embodied in the same hardware item. The use of such words as first, second, third does not represent any order, which can be simply explained as names.

### SUMMARY

The following presents a simplified summary of various aspects of this disclosure in order to provide a basic understanding of such aspects. This summary is not an extensive overview of all contemplated aspects and is intended to neither identify key or critical elements nor delineate the scope of such aspects. Its purpose is to present some concepts of this disclosure in a simplified form as a prelude to the more detailed description that is presented later.

The following paragraphs provide additional support for the claims of subject application.

The present invention pertains to the field of real estate market analytics, specifically to a system and method employing machine learning techniques for estimating a final rent estimate (FRE) of a property. The present disclosure relates to a system for estimating a final rent estimate (FRE) of a property, the system comprising: a computing device receives a property address, the number of bedrooms, and a type of dwelling; and a remote server is coupled to the computing device through a network interface, wherein the remote server comprises: a non-transitory storage device storing: a set of executable routines; and a property database comprising the multiple property location identifiers, wherein each of the property location identifier corresponds to the multiple property data, wherein each property data corresponds to a property address, a date of availability, an occupancy capacity, a build-up area data, a build-up year, and a rent value, wherein the property location identifier is associated with a grid rental index information that is derived, by using at least one strategy selected from: a mean rental value of each property located in a geological grid during a pre-set time period; a median rental value of each property located in the geological grid during the pre-set time period; and a predictive rental index, derived using a regression model, wherein the regression model utilizes at least one parameter selected from: a statistical historical sale of each rental property within the geological grid; at least one statistical historical transaction of each rental property of at least one adjacent geological grid; and a rental value of each geospatial properties of the geological grid; and a microprocessor coupled to the non-transitory storage device, executing the set of routines to: acquire the dwelling input from the computing device; analyse the property database to determine an initial rent estimate (IRE) based on each property located in the geological grid and each adjacent geological grid, wherein a rental value contribution of each property is inversely proportional to a distance from the property location; identify the multiple comparable properties based on: the acquired dwelling input; at least one filter selected from: a spatial filter, a temporal filter, a configuration filter and a variance filter; and the determined IRE; calculate the FRE based on a rental value of the identified multiple comparable properties, wherein a rental value contribution of each comparable property is inversely proportional to a distance from the property location; and display at the computing device, the calculated FRE.

In an embodiment, the microprocessor identifies a pre-set number of the comparable properties and calculates a data confidence score for the estimated FRE.

In an embodiment, the remote server enables the user to export a selected number of the comparable properties and the associated data, which are selected from a property information, a neighbourhood information, a zoning information, a map information, at least one image of the property and at least one street view photo of the property. Further, the remote server generates a graphical representation comprising a comprehensive land history and a land improvement value, corresponding to each of the comparable property.

In an embodiment, the remote server enables auto-filling of the address data based on the received property location, and the user to generate a custom report and integrate a digital signature into the generated custom report.

In an embodiment, the remote server receives an updation input from an authenticated user to update the property database and also uses an encryption technique to ensure confidentiality of the dwelling input and the generated data.

In an embodiment, the comparable properties are sorted based on the at least one sorting keys selected from a nominal distance, a difference of year built, a difference in the number of bedrooms and a listing age.

The present disclosure relates to a method for estimating a final rent estimate (FRE) of a property, wherein the method includes: receiving, at a computing device, a dwelling input from a user, wherein the dwelling input comprises: a property address, the number of bedrooms, and a type of dwelling; and acquiring, at a remote server, the dwelling input from the computing device; analysing, a property database to determine an initial rent estimate (IRE) based on each property located in a geological grid and each adjacent geological grid, wherein a rental value contribution of each property is inversely proportional to a distance from the property location; identifying, the multiple comparable properties based on at least one from: the acquired dwelling input; at least one filter selected from: a spatial filter, a temporal filter, a configuration filter and a variance filter; and the determined IRE; calculating, the FRE based on a rental value of the identified multiple comparable properties, wherein a rental value contribution of each comparable property is inversely proportional to a distance from the property location; and displaying at the computing device, the calculated FRE.

### BRIEF DESCRIPTION OF THE DRAWINGS

The features and advantages of the present disclosure would be more clearly understood from the following description taken in conjunction with the accompanying drawings in which:

FIG. 1 represents overview of a system for estimating a final rent estimate (FRE) of a property, according to some embodiments of the present disclosure.

FIG. 2 illustrates a flow chart to depict a method for estimating market rent value of a property, in accordance with an embodiment of the present disclosure.

FIG. 3A illustrates a user authentication process to enable communication between a computing device and a cloud server, in accordance with an embodiment of the present disclosure.

FIG. 3B illustrates the components of a cloud sever, in accordance with an embodiment of the present disclosure.

FIG. 3C illustrates an integration of a cloud server with multiple cloud computing services, in accordance with an embodiment of the present disclosure.

FIG. 4A to 4C illustrates an exemplary graphical user interface (GUI) for estimating a market rent value of a property, in accordance with an embodiment of the present disclosure.

FIG. 5 illustrates a flowchart for estimating a final rent estimate (FRE) of a property, in accordance with an embodiment of the present disclosure.

### DETAILED DESCRIPTION OF EMBODIMENTS

In the following detailed description of the invention, reference is made to the accompanying drawings that form a part hereof, and in which are shown, by way of illustration, specific embodiments in which the invention may be practiced. In the drawings, like numerals describe substantially similar components throughout the several views. These embodiments are described in sufficient detail to claim those skilled in the art to practice the invention. Other embodiments may be utilized, and structural, logical, and electrical changes may be made without departing from the scope of the present invention. The following detailed description is, therefore, not to be taken in a limiting sense, and the scope of the present invention is defined only by the appended claims and equivalents thereof.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

The present invention pertains to the field of real estate market analytics, specifically to a system 100 and method 200 employing machine learning techniques for estimating a final rent estimate (FRE) of a property.

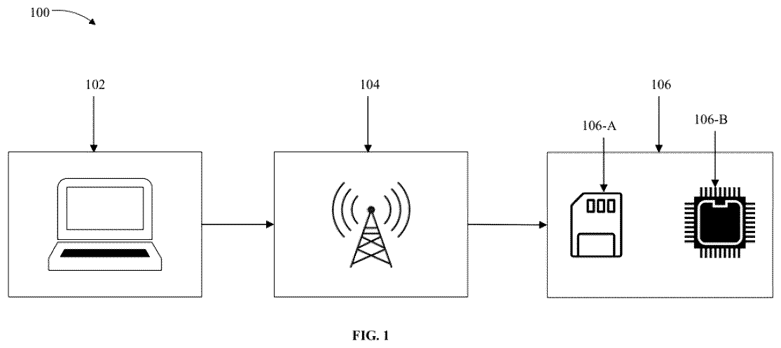

FIG. 1 represents an overview of a system 100 for estimating a final rent estimate (FRE) of a property, according to some embodiments of the present disclosure. system 100 provides an accurate estimation of property rental values based on a multitude of property-related inputs.

The system 100 may include a computing device 102 and a remote server 106, which can be operatively coupled with each other through a network interface 104. The computing device 102 may encompass a range of devices such as personal computers, laptops, tablets, smartphones, etc. The computing device 102 facilitates input of property-related data, referred to as a dwelling input. dwelling input can be understood as collection of information concerning property, including but not limited to a property location (e.g., province name, zip code etc.), a property type input (such as a single-family house, multi-family home, flat, apartment, condominium, or commercial space), and details pertaining to a property occupancy input (how many bedrooms, halls, bathrooms, etc.). Through network interface 104, computing device 102 establishes connection with remote server 106, allowing for data transmission and data retrieval. remote server 106, equipped with computational capabilities and resources, processes and analyses dwelling input, providing valuable insights, recommendations, and outcomes related to property.

In an embodiment, computing device 102 may establish communication with remote server 106 manages data storage, analysis, and execution of various routines. Remote server 106 may comprise a non-transitory storage device labelled as 106-A, designed to retain a collection of executable routines and a property database. property database includes the multiple property location identifiers (such as province, etc.), wherein each property location identifier is individually associated with the multiple property data (name of property, image of property, property number, etc.). Each of property data is utilized for property analysis and evaluation, including a property address, an availability date, an occupancy capacity, the build-up area details, construction or build-up year information, as well as previous or current rent values. remote server 106's non-transitory storage device 106-A and property database facilitate retrieval and processing of property-related information, enabling system 100 to provide insights, recommendations, and data-driven outcomes to the users.

In an embodiment, each property location identifier is linked to a grid rental index information, which is derived using one or more strategic methods/models. The grid rental index information encapsulates the rental values within a geological grid, which can be referred as a uniform or ununiform sub-sections of a geographical area. The geological grids can be visualized as a mesh overlaying a map, partitioning into a predetermined number of rows and columns based on the chosen reference grid type. The grid rental index information can be derived based on multiple strategies such as mean rental value of each property located in a geological grid during a pre-set time period, median rental value of each property located in the geological grid during a pre-set time period, and a predictive rental value. The mean rental value is the average cost of rent for all properties located within a specific geographical grid (an area demarcated for the analysis) during a particular time period (e.g., last 3 months, 6 months etc.). The mean value provides a good overall indication of rental prices but can be skewed by extremely high or low values. The median rental value is the middle value of rent for all properties located within a particular geographical grid during a set time period. If there is an even number of properties, the median can be average of the two middle numbers. Unlike the mean, the median rental value may be used, which provides a measure less influenced by extremely high or low rental values and presents a more typical rental value.

In an embodiment, the predictive rental value can be calculated utilizing a regression model, which may use multiple parameters as variables selected from (a) statistical historical sale of each rental property within the geological grid, (b) at least one statistical historical transaction of each rental property of at least one adjacent geological grid, (c) rental value of each geospatial property within the geological grid, (d) target type of dwelling (e.g., single-family home, apartment, townhouse, etc.), and (d) target number of bedrooms (e.g., number of bedroom, bedroom for kids, guest bedroom etc.).

The statistical historical sale of each rental property within the geological grid represents the sale prices and/or rent value of each rental property within geographical grid, and also indicate potential rental prices, particularly when taking into account the return on investment that property owners might be seeking. By incorporating data from neighbouring geographical grid, present disclosure may also incorporate regional factors (which might impact rental prices) in form of at least one statistical historical transaction of each rental property of at least one adjacent geological grid. The different types of dwellings often have different rental values.

The rental value of each geospatial property within the geological grid represents existing rental values for properties within the grid. Within each geographical grid, every rental property can be considered as geospatial property which may be associated with property related data, current rent being currently paid by tenants to landlords for the use of the property, physical location (geospatial coordinates like latitude and longitude) and other attributes such as size (square footage), number of rooms, type of dwelling (apartment, single-family home, etc.), age of the building, proximity to amenities, and more. Thereby, the rental value of each geospatial property within geological grid provides a snapshot of the current rental market in that area, and also forms a basis for predictive models, helping to forecast future rental values based on current market conditions and property attributes.

In an embodiment, the remote server 106 comprises a microprocessor 106-B that interacts with the non-transitory storage device 106-A, enabling a smooth execution of the predefined routines stored therein. The microprocessor 106-B orchestrates acquisition of the dwelling input from the computing device 102. The microprocessor 106-B proceeds to analyse property database, by utilizing complex algorithms to calculate an initial rent estimate (IRE). The IRE is derived from properties within and around the geographical grid encompassing the property, providing a context-rich initial estimate. Further, for refining the IRE, the microprocessor 106-B applies a set of filters, such as spatial, temporal, configuration, or variance, to the acquired dwelling input and the IRE, effectively identifying the comparable properties.

In one embodiment, the calculation of the IRE is performed through geographical proximity. The calculation involves an inversely proportional weighting mechanism to the rental value of each property, based on its distance from the location (based on provided property location). In simpler terms, properties in close proximity to the input location have a higher influence on the IRE, while far away properties have a lesser impact. Such approach ensures that the local market conditions, which typically have a more direct and immediate influence on the rental value of a property, are accurately represented in the IRE. By incorporating the spatial relationship among properties, the system 100 captures the influence of the local neighbourhood characteristics, the property market trends, and the demand-supply dynamics that tend to be more pronounced at a local level.

In an embodiment, the multiple comparable properties are selected by cross-referencing the user's dwelling input, applied filters, and the calculated IRE. Filters can include various elements like spatial (geographical proximity), temporal (time-related factors), configuration (property characteristics), and variance (statistical dispersion) filters.

The spatial filtering involves consideration of only properties which are within a certain distance of the subject property. The properties that are close to each other are more likely to have similar rental values due to shared characteristics such as the same neighbourhood, similar access to amenities, shared local economic conditions, etc. The temporal filtering enables inclusion of only rental listings that are newer than a certain date or time period. The temporal filtering ensures that data reflects current market conditions. For example, predicting rental values for the current year, user might choose to include only listings from the past year or two, rather than older listings which may not accurately represent the current rental market.

Configuration filtering involves including only rental listings that have the same configuration as the subject property, in terms of the type of dwelling (apartment/condo, house, townhouse, basement) and number of bedrooms. Configuration filter has a significant impact on rental values. For example, a three-bedroom house is likely to have a different rental value than a one-bedroom apartment, even if they are in the same area.

IRE variance filtering enables the selection of rental listings with rent prices within a certain percentage (T0) difference from the calculated IRE. The T0 value would be set differently for each type of dwelling such as basements (T0b), apartments (T0a), townhouses (T0t), and houses (T0h).

In an embodiment, the identified comparable properties can be sorted based on numerous keys, including but not limited to, a nominal distance, a difference of year built, a difference in the number of bedrooms and a listing age. The system 100 can deploy nested/multi-level/hierarchical sorting in order of priority as nominal distance, difference of year built, difference in the number of bedrooms and listing age. Briefly, comparable properties are sorted based on distance closer to remoter from the target property, therefore, the comparable property can be prioritized. Further, comparable properties which were built around the same time as the target property may have higher priority. Comparable properties can be sorted based on the difference in the number of bedrooms they have compared to the target property. Comparable properties with a closer number of bedrooms to the target property are given higher priority. Listing age is referring to how recently the property is listed for rent. More recent listings might be considered more relevant for the comparison. If two properties are similar in other respects, but one was listed a week ago and the other a month ago, the more recent listing would be given priority.

To enable sorting of comparable properties, a minimum number of specific comparable properties (C) would be required. In case, number of comparable properties are smaller than C (#comparables <C), the remote server 106 may relax one or more filters (e.g., spatial filter, temporal filter, configuration filter and variance filter) to enable to identify more comparable properties.

The relaxation happens in two dimensions (a) number of bedrooms: remote server 106 initiates by including properties with a different number of bedrooms. For example, if the target property is a 3-bedroom house, the system 100 may start considering 2-bedroom and 4-bedroom houses as well. (b) TRE variance: If relaxing the number of bedrooms failed to provide sufficient number of comparable properties, remote server 106 can consider properties with a wider range of IRE values. In case, remote server 106 still fails to identify enough number of comparable properties after relaxing both of aforementioned filters, remote server 106 expands the search area to include the nearest cities/provenances or neighborhood geological grids. The maximum number of additional cities/provenances or neighborhood geological grids included in the search can be capped at 3 to limit the complexity of the analysis. Alternatively, user can provide input with regard to capping count.

The system 100 ensures, the selected properties which align closely with the user's requirements and the specific market conditions, reflect in the IRE. Each identified comparable property can be another embodiment, the system 100 may estimate FRE by leveraging the rental values of the identified comparable properties. Rental value contribution of each comparable property can be inversely proportional to its distance from the location (provided in property location). In simpler terms, the closer comparable property is to the property location, the greater is influence on the FRE. The proximity-driven weighting process ensures that the FRE reflects the most relevant and immediate market conditions, taking into account not just the characteristics of similar properties but also their geographical relevance. Thus, the estimated FRE provides a highly precise and localized rent estimate, thereby reliable indicator of the property's potential market rent value.

In an optional embodiment, system 100 can integrate machine learning techniques to process the acquired dwelling input and analyse the multiple comparable properties. The machine learning technique allows the system 100 to perform a self-improvement feedback loop, whereby each performed estimation aids in enhancing its predictive accuracy and operational efficiency. With each successive iteration, the system 100 refines the underlying machine learning technique, honing its ability to accurately predict rental values. The machine learning technique offers significant advantages. For instance, the system 100 can be capable of adapting to changing market conditions, trends, and anomalies, continually fine-tuning its approach to deliver reliable, timely, and accurate rental estimates. Thus, the application of machine learning technique in system 100 marks a significant advancement in property valuation technology, pushing the boundaries of precision, scalability, and adaptability in the FRE.

In another embodiment, system 100 displays the estimated FRE on the user's computing device 102. The user, therefore, receives a substantiated estimation, meticulously derived from a pool of comparable properties, historic rental values, and geospatial factors, providing an insightful outlook of the property's potential rental income.

In an embodiment, system 100 offers a variety of additional features that cater to different user needs. system 100 could further calculate and display minimum and maximum market rent values. system 100 can be further configured to enable display of data confidence score, indicating the number of comparable properties used in estimating FRE of the property.

Moreover, system 100 can provide export functionalities, enabling user to export property information, neighbourhood information, zoning, map information, and street view photos to a custom report. User can also visualize a land history and a land improvement value for each comparable property, offering valuable insights into the property's past and potential future value.

In an embodiment, user can export the custom report to an editing software for further editing, or even include their digital signatures in the report before finalizing document. With features like auto-filling of address data based on dwelling input, system 100 amplifies user experience significantly.

In an embodiment, system 100 leverages machine learning not only for the analysis of data but also for regular updating of property database, ensuring real-time accuracy of property data. The encryption and security measure, ensures data integrity and user confidentiality, promoting trust and reliability in system 100.

In an embodiment, system 100 for estimating the market rent value of the property, uses machine learning techniques to analyse property database, resulting in highly precise rent range determinations based on dwelling input. system 100 identifies comparable properties within a predefined distance range, ensuring the relevance of data for rent estimation. By utilizing machine learning, system 100 derives the FRE, adapting to varied market conditions and property characteristics. The estimated value is presented on computing device 102, offering an understandable interaction. Efficient data management is achieved via non-transitory storage device 106-A, ensuring the data retrieval and real-time processing. Furthermore, its ability to process dwelling inputs, such as location, property type, and occupancy, lends system 100 versatility and wide applicability in real estate market, catering to different user needs and scenarios.

In one embodiment, microprocessor 106-B in system 100 can calculate and present a minimum and maximum market rent value. By utilizing acquired dwelling input, system 100 can provide a range of rental values that are considered reasonable for the specific property. Such additional capability allows user to have better understanding of rental income range, providing valuable insights for property owners, landlords, or real estate professionals when determining the most appropriate rent value. system 100, by considering both the lower and upper bounds of rental market, enables user to make informed decisions about pricing of property.

In a particular implementation, microprocessor 106-B in system 100 possesses the capability to identify and analyse any number of comparable properties. Such selection is made by considering their recent or historical data within any time frame, say for instance, up to 365 days. By categorizing these comparable properties, system 100 offers user a perspective of rental market trends. By considering a range of comparable properties, user gain insights into the market dynamics and can set a competitive rental price that aligns with the prevailing trends, ultimately maximizing the property's potential value.

In a specific embodiment, microprocessor 106-B of system 100 is equipped with ability to calculate and present a data confidence score that serves as an indicator of reliability and accuracy of estimated FRE by revealing the number of comparable properties used in estimation process. By considering the amount of available data, user may gain insights into robustness of the rental value estimation. A higher data confidence score suggests a larger pool of comparable properties, enhancing credibility of the estimation. The confidence score empowers user to have better understanding of the level of confidence they can place in rental value estimation, aiding them in making informed decisions about their property's rental value.

In a particular embodiment, system 100 incorporates remote server 106 that offers user capability to export the custom report encompassing all pertinent property details, which includes information about the property, neighbourhood characteristics, zoning regulations, map data, at least one image of property and at least one street view photo of the property. Such feature empowers user to create visually appealing reports that can serve multiple purposes. User can share these reports with others, use them for personal reference, or even present them in professional contexts. By consolidating all aforementioned relevant information into a single document (custom report), system 100 enhances convenience and enables user to effectively communicate property details.

In yet another embodiment, remote server 106 within system 100 presents user with a detailed land history and a land improvement value for each comparable property to provide valuable additional insights into the property's past, including noteworthy alterations or enhancements made to the land over time. By understanding land history, user can better assess overall value and desirability of the property. The information allows user to consider factors such as previous land use, renovations, or developments, which can significantly impact a property's appeal and potential rental value.

In an embodiment, system 100 allows user to generate and export custom report to the editing software for additional editing purposes. User can leverage the editing software's editing tools to make changes to the report's layout, add additional information, incorporate their own branding elements, or tailor the content to suit required preferences.

In an embodiment, user of system 100 can integrate a digital signature within the custom report prior to finalization. Such feature brings an additional level of authenticity to the report, as user can digitally sign on information presented.

In a specific implementation, remote server 106 can employ an auto-fill feature for address data. Such capability streamlines user experience by automatically populating relevant property details based on provided property location. User can simply enter address, and system 100 can swiftly retrieve and populate required information such as street name, city, state, and postal code. By automating the filling process, user saves valuable time and effort that would otherwise be spent manually entering the address details, also reduce error.

In a specific embodiment, remote server 106 within system 100 utilizes machine learning technique to determine an optimum comparable property. The algorithms and statistical models analyse vast amounts of data and identify properties that closely match the given criteria for estimating FRE. By leveraging machine learning, system 100 can learn patterns, trends, and relationships within the data, thereby enabling user with more reliable and precise estimations, ultimately enhancing overall accuracy and effectiveness of the rental value estimation process.

In an embodiment, remote server 106 integrates with a map, which enables system 100 to provide a navigation path for each comparable property. When user interacts with system 100, searching for properties or comparing them, remote server 106 utilizes the map integration to generate a navigation path for each comparable property. The navigation path assists user in visualizing location and proximity of the properties in relation to each other. By displaying the navigation path on a map interface, user can easily understand geographical layout of the properties and assess their convenience in terms of proximity to various landmarks or amenities. The integration with map enhances user experience and provides a practical way to explore and compare different properties, regarding their location and accessibility.

In a specific embodiment, property database within system 100 is maintained and regularly updated to ensure the real-time accuracy of property data. property database encompasses vital information, including property addresses, availability dates, occupancy capacity, build-up area data, build-up year, and rent value. By consistently updating the database, system 100 ensures that user have access to the most current and reliable information.

In an embodiment, system 100 enables an authenticated user to update property database by providing an updation input to remote server 106. The updation input can include details such as changes in property features, amenities, or condition, as well as the addition of new properties. Database updation enables users to access the most up-to-date and relevant information when estimating market rent values or conducting property searches, enhancing the overall usability and effectiveness of system 100.

In an embodiment, system 100 employs the encryption and security measures to ensure safety and confidentiality of dwelling input and the generated data. The encryption includes employing robust encryption protocols, access controls, and data protection mechanisms to mitigate the risk of unauthorized access, data breaches, and information leaks. system 100 prioritizes the privacy and security of user data throughout the entire process.

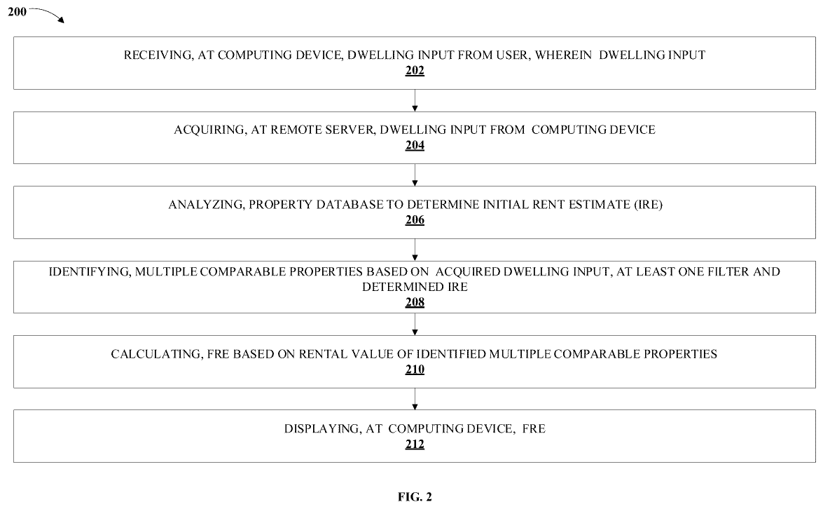

FIG. 2 illustrates a method 200 for estimating a market rent value of a property, in accordance with an embodiment of the present disclosure. Firstly, the method begins with step 202, receiving a dwelling input from a user at a computing device 102 (e.g., smartphone, tablet etc.). The dwelling input can include: a property location, which can indicate the geographical area where the property is situated; a property type input, which can refer to the nature of the property such as whether it is a single-family home, an apartment, a duplex, or a commercial property; and a property occupancy input, which can indicate whether the property is currently vacant or occupied, or the number of bedrooms.

Once these inputs are received, at step 204 the computing device 102 transmits the dwelling input to a remote server 106, through network interface 104, which enables the transmission of data between computing device 102 and remote server 106.

Subsequently, at step 206, the remote server 106 analyses a property database to determine an initial rent estimate (IRE). The property database contains detailed records of properties, including but not limited to their locations, types, occupancy statuses, and historical or current rental values. The analysis involves examining each property located in a geological grid, as well as in each adjacent geological grid, relative to the property location. The rental value contribution of each property to be inversely proportional to the distance from the property location, meaning that properties closer to the input location will have a higher impact on the IRE.

Further, at step 208, the method 200 identifies multiple comparable properties based on the acquired dwelling input, as well as certain filters. These filters can include a spatial filter (relating to the geographical location or physical space of the properties), a temporal filter (relating to the time-related factors such as rental listings that are newer than a certain date or time period), a configuration filter (pertaining to the features or configuration of the properties like the number of bedrooms or bathrooms, square footage, amenities, etc.), and a variance filter (which could relate to variations in property prices in the location over a certain time period). The identified properties and the determined IRE together aid in the next step of the process.

At step 210, calculates the FRE based on the rental value of the identified multiple comparable properties. Similar to the IRE calculation, the rental value contribution of each comparable property is inversely proportional to its distance from the property location. Distance based FRE calculation allows for more precise and relevant estimations, giving more weightage to comparable properties closer to the property location.

Lastly, the at step 212, displays the calculated FRE at the computing device 102. The FRE can be presented to the user in a user-friendly interface, allowing them to easily understand and make use of the provided estimate. The display could also offer additional information like a breakdown of the calculations, comparisons with other properties, or potential trends in rental prices.

In an exemplary embodiment, method 200 may involve sorting of identified comparable properties based on specific sorting keys. These keys include nominal distance (geographical proximity to the target property), difference of year built (age similarity to the target property), difference in the number of bedrooms (match in bedroom count with the target property), and listing age (how recently the property was listed for rent or sale). The sorting process ensures that more relevant and similar properties are presented to the user.

In an embodiment, the dwelling input is enhanced by including an additional parameter selected from a predetermined list of options. The additional parameters can be selected from list include the number of bedrooms, indicating size and capacity of the dwelling, and the number of bathrooms, providing information about sanitary facilities available. The input can also specify presence of one or more amenities, such as a swimming pool or fitness center, which can enhance desirability of property. Furthermore, the parameter can indicate availability of a parking facility, an essential consideration for the user. Lastly, the interior finishing status parameter describes the current condition of the dwelling's interior, whether it is fully finished, partially finished, or in need of renovation. By incorporating these parameters, the method 200 ensures accurate representation of the property, facilitating a more precise estimation of its market rent value.

In an embodiment, the method 200 involves remote server 106 to generate a detailed report that provides a breakdown of the various property features that contribute to estimation of FRE. Detailed report serves as a comprehensive analysis of dwelling, highlighting the key factors that influence its rental value. Detailed report may include information such as the square footage, location, amenities, condition, and other relevant details about the property. By examining these individual features and their impact on the rental value, the report offers insights into the overall estimation process.

An embodiment incorporates predictive analytics features within remote server 106. The predictive analytics feature utilizes historical and current market trends to estimate future market value of rent for the property. By analysing trends and patterns in rental market, predictive analytics algorithm can project the potential changes in rent prices over time. Such information can be valuable for property owners, investors, or renters who are interested in understanding the potential rental value of a property in future. The predictive analytics feature adds a forward-looking perspective to estimation process.

In an exemplary implementation, present disclosure provides to a computer-readable medium that houses a set of instructions. When executed by a processor 106-B, the instructions to carry out operations for estimating a final rent estimate (FRE) of a property. First, the instructions facilitate receiving a dwelling input from a user at the computing device 102. The dwelling input can include elements like a property location, a property type input, or a property occupancy input, which collectively describe the property in question. The dwelling input can be transmitted to a remote server 106 that can access a property database to calculate an initial rent estimate (IRE). The remote server 106 analyses properties within the provided location and adjacent regions (geological grids), using a rental value contribution protocol where each property's influence is inversely proportional to distance thereof from the property location input. Next, the instructions allow the identification of comparable properties based on the acquired dwelling input and specific filters, which may include spatial, temporal, configuration, or variance filters, as well as the previously calculated IRE. The filters help refine the selection to properties most similar to the user's input. Subsequently, the instructions guide the calculation of the FRE based on the rental values of the identified comparable properties. Here, a similar inverse proportional function is used, giving more weight to properties closer to the property location. Finally, the instructions enable the display of the calculated FRE at the computing device 102, presenting the user with the estimate and potentially additional details or comparisons.

In essence, the computer-readable medium stores a sophisticated set of instructions that, when executed, aid in delivering a user-friendly, accurate, and efficient property rent estimation tool.

In an exemplary aspect, Jacob is a real estate appraiser who specializes in rental properties. When, a new client, Mrs. Sullivan, comes to him for help in setting a rental price for her three-bedroom townhouse at 123 Park Street. Jacob accesses laptop (i.e., computing device 102) to input Mrs. Sullivan's property details including the property's address (e.g., 123 Park Street), the number of bedrooms (e.g., three), and the type of dwelling (e.g., townhouse). The server (i.e., remote server 106) acquires property details from laptop through internet (i.e., network interface 104). The server comprises a property database and a non-transitory storage device, which contains multiple property data sets and a set of executable routines. The server starts to analyze the property database to determine IRE that aligns with requirement of client. The IRE considers each property located in the same geological grid as 123 Park Street, and each adjacent grid, factoring in the distance from the location input. Further, the server identifies comparable properties based on the client property data (e.g., a three-bedroom townhouse located at 123 Park Street), the IRE, and additional filters such as spatial, temporal, configuration, and variance filters. Moreover, the server calculates the FRE, using the rental value of the identified comparable properties, factoring in the distance from the location input. The cloud server renders presentation depicting calculated FRE onto Jacob's laptop. Jacob can export property information, neighborhood information, zoning, map information, and street view photos to custom report for Mrs. Sullivan.

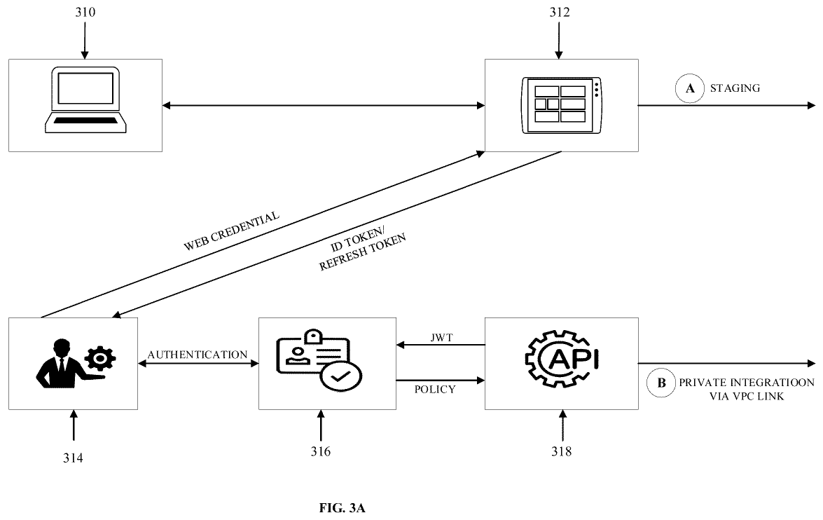

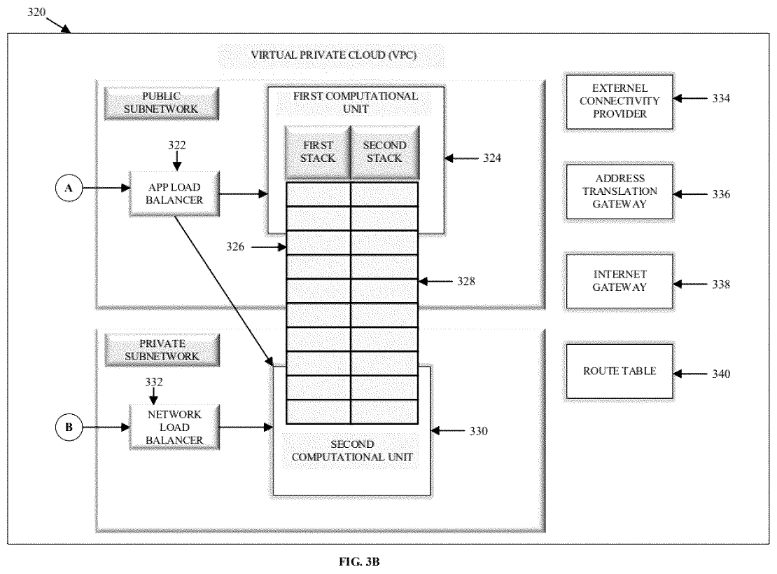

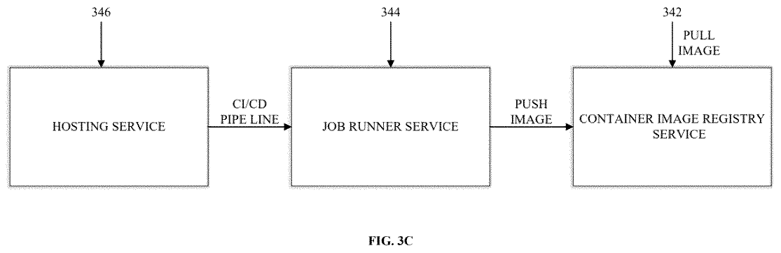

FIG. 3A illustrates a user authentication process to enable communication between computing machine 310 (same as computing device 102) and cloud server 320 (same as remote server 106), in accordance with an embodiment of the present disclosure. As illustrated, user interacts with the cloud server 320 (also known as virtual private cloud 320 (VPC)) through the web application 312, which runs on computing machine 310. The web application 312, acting as a mediator, is tasked with verifying identity of the user, thereby ensuring secure interaction. To verify user, web application 312 can access an authentication service provider 314 such as AWS Cognito. The authentication service provider 314 generates temporary web credentials to distinguish between authenticated users and guest users. An identity token, as proof of successful verification, may be provided to authenticated user. The identity token undergoes validation by ID token verifier 316 (such as JWT verifier, etc.), which accepts two arguments—token string value, and secret key. Identity token's validity is confirmed, if it matches with the secret key. Following validation process, a policy can be framed which outlines user's privileges and access. The subsequent communication between cloud server 320 and the web application 312 is facilitated by an API gateway 318 (such as Amazon API, etc.), which regulates access and ensures adherence to usage policies.

FIG. 3B illustrates components of cloud sever 320, in accordance with an embodiment of the present disclosure. As depicted, cloud server 320 empowers developers to launch various resources, including computational units (for example elastic compute cloud (EC2) instances), within a logically isolated and user-defined virtual network that mimics a traditional network that would typically be found in a personal data center, harnessing the scalability of cloud computing infrastructure. The cloud server 320's architecture can include a public subnetwork, linked to a route table 340, and having a path to an internet gateway 338, granting public internet access to the subnetwork. The public subnetwork may incorporate several components: an app load balancer 322, a first computational unit 324, a first stack 326 and a second stack 328 which are associated with a private subnetwork, an external connectivity provider 334, an address translation gateway 336, internet gateway 338, and route table 340. These components function together within the cloud server 320 to create a secure, efficient, and scalable cloud computing environment.

In a particular implementation, the app load balancer 322 functions as a traffic manager for incoming application traffic, distributing it across various targets like computational units (such as EC2 instances) situated in multiple availability zones (different geographical regions for launching of the computational units). The distribution mechanism enhances the resilience and availability of web application 312. By evenly allocating application load, the app load balancer 322 ensures that no single computational unit is overwhelmed, thus preventing bottlenecks and improving overall application performance.

In a particular implementation, the first computational unit 324, exemplified by an EC2 instance, offers flexible, instantly available computing power within a cloud-based environment. The utilization of first computational unit 324 reduces hardware expenses, enabling development and deployment of web application 312. The operational flexibility of first computational unit 324 allows users to initiate virtual servers based on the requirements, regulate security protocols, manage network settings, and handle storage. The first computational unit 324 can expand capacity to manage intensive computational tasks such as annual processes or sudden upsurges in website traffic, known as scaling up. Conversely, when the demand drops, first computational unit 324 allows for a reduction in computing capacity, referred to as scaling down, thereby optimizing resource usage and cost.

In one implementation, first stack 326 functions as an integrated collection of cloud computing resources (such as docker agents, flask services, etc.), which could be housed within either public or private subnetwork, managed as a unified entity. Essentially, creating, updating, or deleting stacks allows for simultaneous management of the constituent resources. For instance, the first stack 326 could encompass all necessary resources to operate web application 312, such as a database and networking rules. If need for that web application 312 ceases to exist, first stack 326 can be deleted. This action triggers an automatic deletion of all related resources tied to the first stack 326.

In a particular embodiment, the second stack 328 serves as a unified assembly of cloud computing assets, potentially located within either public or private subnetwork, managed as a single unit. The creation, modification, or deletion of stacks facilitates the concurrent administration of their respective components. For example, the second stack 328 might incorporate all the resources needed to run web application 312, such as a database and network regulations. If the web application 312 is no longer required, second stack 328 can be deleted, instigating an automatic removal of all interconnected resources within the stack.

In a specific configuration, the second computational unit 330, illustrated by Amazon's Elastic Compute Cloud (EC2), provides scalable, on-demand computational power in a cloud setting. The use of second computational unit 330 substantially decreases hardware costs, fostering more efficient and rapid web application 312's development and deployment. The adaptable operation of second computational unit 330 lets users to activate a varying quantity of virtual servers based on their needs, control security measures, adjust network configurations, and manage storage. The second computational unit 330 can increase capacity to tackle heavy computational jobs, such as annual operations or unexpected spikes in website traffic, a process known as scaling up. On the other hand, when demand subsides, second computational unit 330 allows for a reduction in computational capacity, termed as scaling down, thereby maximizing resource efficiency and minimizing costs.

In an embodiment, the network load balancer 332 can be used in private subnetwork to efficiently manage network traffic. The network load balancer 332, designed to handle millions of requests per second, can evenly distribute incoming network traffic across multiple computational units to optimize performance, reliability, and latency reduction. The network load balancer 332 uses algorithms to determine the computation unit that can fulfil an incoming request, with decisions based on various factors such as current traffic load, computation unit availability, and network latency. The network load balancer 332 ensures that no single computational unit is overwhelmed with traffic, enhancing overall efficiency of cloud server 320 and improving user experience. In context of private subnetwork, it adds an additional layer of security by preventing direct traffic to the second computational unit 330, contributing to the cloud server 320's privacy and security framework. Through its automatic health checks, the network load balancer 332 reroutes traffic away from computational units, further enhancing network reliability.

In an embodiment, the external connectivity provider 334 (such as bastion host) is a gateway used to securely connect to second computational unit 330 located in private subnetwork. Acting as a security measure, the external connectivity provider 334 is directly exposed to the internet, serving as a controlled entry point to the protected assets within the private subnetwork. The external connectivity provider 334 mitigates the risk of exposing these assets to the public subnetwork.

In an embodiment, the address translation gateway 336 (such as network address translation (NAT) gateway) is a networking component that allows second computational unit 330 in the private subnetwork to connect to internet or other cloud computing services, while simultaneously preventing the internet from initiating a connection with the second computational unit 330. Essentially, the address translation gateway 336 enables outbound communication from private subnetwork to internet, providing a degree of security by masking the private IP addresses. The address translation gateway 336 translates the private IP addresses of instances to a public IP address, and vice versa, allowing responses to outgoing requests to return, but blocking inbound traffic initiated from the internet.

In an embodiment, the Internet Gateway 338 serves as a routing center that allows first computational unit 324 and second computational unit 330 within the VPC 320 to communicate with the internet. Essentially, it is a horizontally scalable, redundant, and highly available cloud computing component that provides a path for network traffic between the VPC 320 and internet. The Internet Gateway 338 supports two types of traffic: inbound (from internet to VPC 320) and outbound (from VPC 320 to internet). Furthermore, it helps perform network address translation for instances that have been assigned public IPv4 addresses. An important characteristic is that the Internet Gateway 338 allows all computational units, regardless of their associated subnets (public or private), to have access to the internet, provided the network access control lists and security group rules allow it.

In an embodiment, the route table 340 functions as a navigational guide for network traffic, housing a collection of rules known as routes. Each subnetwork within the VPC 320 can be linked to the route table 340, dictating traffic flow between the subnetworks and other networks, including the internet and other segments of VPC 320.

FIG. 3C illustrates an integration of cloud server 320 with the multiple cloud computing services, in accordance with an embodiment of the present disclosure. As illustrated, the cloud server 320, extends its functionality by establishing connections with other services and tools, including a container image registry service 342, a job runner service 344, and a hosting service 346.

In a further embodiment, the container image registry service 342 (such as Amazon Elastic Container Registry) serves as a fully managed Docker registry, empowering the cloud server 320 to securely store, manage, and deploy Docker container images. These images, essentially lightweight standalone software packages, contain everything needed to run the web application 312, ensuring consistency across different computing environments.

On the other hand, job runner service 344 (such as Gitlab runner) can be a tool that runs tasks or “jobs” in distinct stages of the cloud server 320's operations, facilitating a continuous integration/continuous deployment (CI/CD) process. This allows developers to automatically test and prepare code for production, significantly enhancing the cloud server 320's workflow efficiency.

In an embodiment, the hosting service 346 (such as Gitlab on-premises) offers an additional control and customization over the cloud server 320's functionalities. As a self-hosted version, the hosting service 346 can be installed on the cloud server 320 and configured according to the unique needs of the cloud server 320, thereby increasing the flexibility.

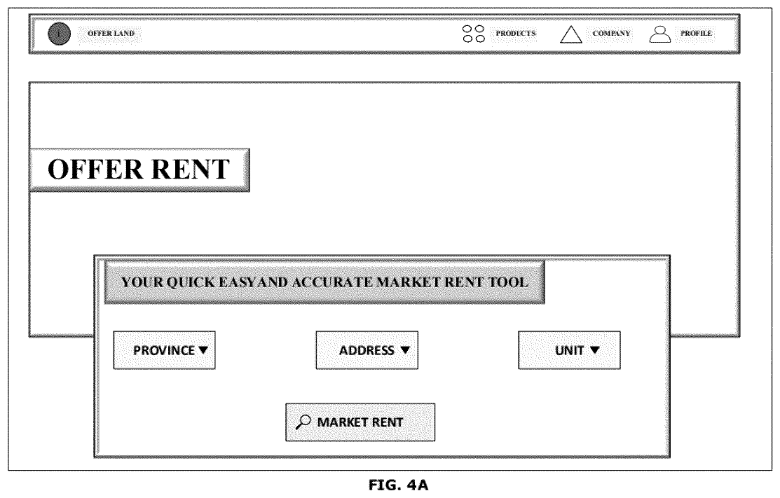

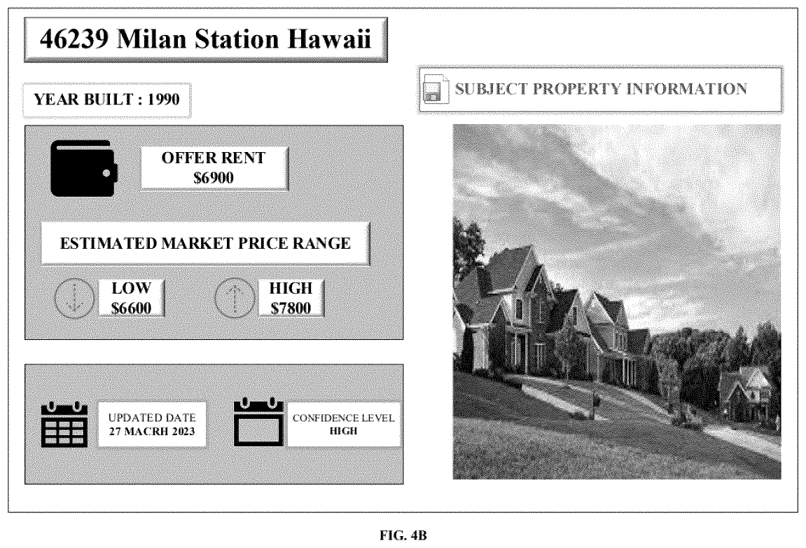

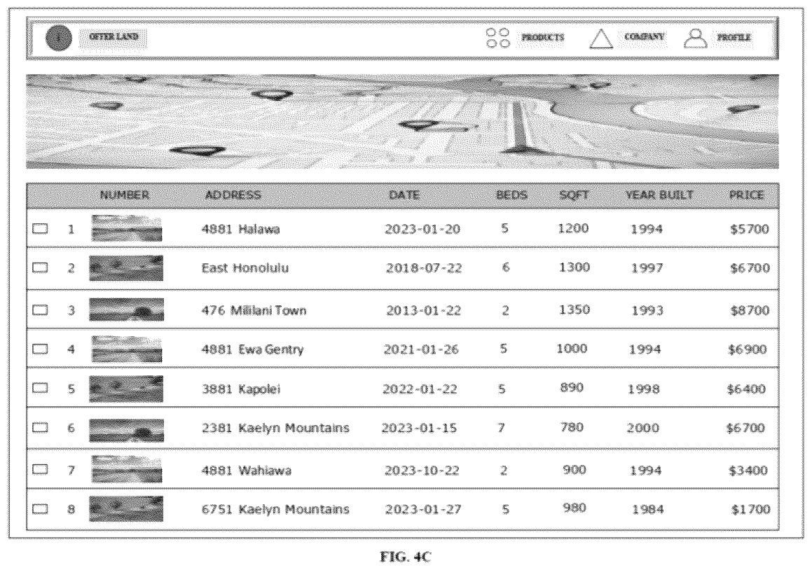

FIG. 4A to 4C illustrates an exemplary graphical user interface (GUI) for estimating a market rent value of a property, in accordance with an embodiment of the present disclosure. As illustrated (in FIG. 4A) the GUI provides an intuitive, visual medium for users to input data about the required properties, vital for determining appropriate rental estimates. Dwelling input may include the property address, number of bedrooms, and type of dwelling. Within the GUI, property location is often managed through text fields or drop-down menus, enabling users to specify the property's geographic location, ranging from a particular street address to a more broad-based area such as a city or neighbourhood. For property type input, options like checkboxes, radio buttons, or selection lists allow users to define the dwelling's category, be it a single-family home, condo, or apartment. property occupancy input is facilitated by numeric fields or sliders where users can indicate the dwelling's intended or current usage, based on potential inhabitants or number of bedrooms. The GUI thus merges simplicity and functionality, enabling a streamlined user experience. Throughout the present disclosure the term ‘occupancy’ refers to the number of bedrooms of the property.

The FIG. 4B illustrates GUI that employs interactive elements to depict the estimated optimal market rent value, alongside other property-related details. The GUI presents computed rent value, highlighted for easy visibility, serving as piece of information for users. Additionally, the GUI may show minimum and maximum rent range, confidence scores, comparable properties, and their distances. User-friendly visualization methods such as charts, graphs, or interactive maps may be used to display the information in a digestible format. Overall, the GUI simplifies complex data, aiding users in understanding and utilizing the rent estimation outcomes.

The FIG. 4C visualizes the multiple comparable properties in a user-friendly format. The GUI may display a list or a map pinpointing the locations of comparable properties. Details of comparable properties, such as their addresses, occupancy capacities, build-up areas, year of construction, and market rent values, are presented in a structured and easy-to-navigate manner. The GUI may also feature interactive elements, such as clickable property markers, providing more in-depth information on demand. Such visualization approach offers users an intuitive and comprehensive understanding of the market landscape.

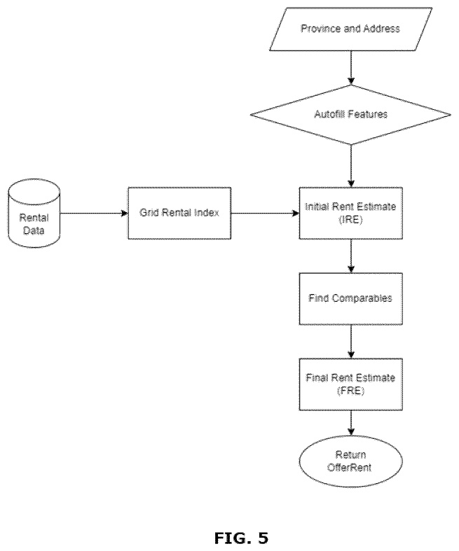

FIG. 5 illustrates a flowchart for estimating a final rent value (FRE) of a property, in accordance with an embodiment of the present disclosure. As illustrated, the flowchart depicts an autofill feature that automatically pulls property features from various data sources such as local data, public data, or third-party providers, given a property's address.

In an embodiment, the flowchart illustrates a grid rental index (province-specific model), which functions within distinct rectangular grids. The rectangular grids provide the structural framework for the statistical model, underpinning its granularity and preserving spatial relationships. The grid rental index for each rectangular grid can be computed at any given point in time, deploying one of several strategies: mean or median rental value of each property within a rectangular grid during a predetermined time frame, or utilizing a regression model that predicts the grid rental index using historical sale statistics and transactions of rental properties within or adjacent to the grid, as well as rental values of each geospatial property within the rectangular grid. The input includes dwelling type and the number of bedrooms. The model operates on a per-dwelling-type and per-number-of-bedroom basis, imposing constraints to ensure logical predictions. The grid rental index is specifically designed to ensure that the index for ‘N’ number of bedrooms is invariably lesser than the index for ‘N+1’ number of bedrooms, maintaining the sanity of predictions.

In an embodiment, the property features are processed using a first weighted linear interpolation algorithm. All the rental indices corresponding to property's features contribute to property's initial rental estimation (IRE). Each rectangular grid's contribution is inversely proportional to its distance from the property. The algorithm requires at least three points to form a convex hull, but if it is not available, the rectangular grid selection criteria are relaxed iteratively until a convex hull is formed.

In an embodiment, the IRE calculated from the above process is used to find similar properties. The calculation involves a spatial, a temporal, a configuration, and IRE variance filtering which is applied to find the comparable properties. If the number of comparable properties is too low, the filtering criteria can be relaxed or expanded to nearby cities. Comparable properties are then sorted based on distance from the property, year built, number of bedrooms (if more than four), and listing age on the market.

In an embodiment, the final rental estimate (FRE) is derived from comparable properties and their list prices through a second weighted linear interpolation algorithm. Each comparable property's weight is inversely proportional to its distance from the property, ensuring accuracy in the rental price estimation.

Throughout the present disclosure, the term ‘Artificial intelligence (AI)’ as used herein relates to any mechanism or computationally intelligent system that combines knowledge, techniques, and methodologies for controlling a bot or other element within a computing environment. Furthermore, the artificial intelligence (AI) is configured to apply knowledge and that can adapt it-self and learn to do better in changing environments. Additionally, employing any computationally intelligent technique, the artificial intelligence (AI) is operable to adapt to unknown or changing environment for better performance. The artificial intelligence (AI) includes fuzzy logic engines, decision-making engines, preset targeting accuracy levels, and/or programmatically intelligent software.

Throughout the present disclosure, the term ‘processing means’ or ‘microprocessor’ 106-B or ‘processor’ or ‘processors’ includes, but is not limited to, a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

The term “non-transitory storage device” 106-A or “storage” or “memory,” as used herein relates to a random-access memory, read only memory and variants thereof, in which a computer can store data or software for any duration.

Operations in accordance with a variety of aspects of the disclosure is described above would not have to be performed in the precise order described. Rather, various steps can be handled in reverse order or simultaneously or not at all.

1: A system for estimating a final rent estimate (FRE) of a property, the system comprising:
a computing device receives a dwelling input from a user, wherein the dwelling input comprises a property address, the number of bedrooms, and a type of dwelling; and
a remote server is coupled to the computing device through a network interface, wherein the remote server comprises:
a non-transitory storage device storing:
a set of executable routines; and
a property database comprising the multiple property location identifiers, wherein each of the property location identifier corresponds to the multiple property data, wherein each property data corresponds to a property address, a date of availability, an occupancy capacity, a build-up area data, a build-up year, and a rent value, wherein the property location identifier is associated with a grid rental index information that is derived, by using at least one strategy selected from:
a mean rental value of each property located in a geological grid during a pre-set time period;
a median rental value of each property located in the geological grid during the pre-set time period; and
a predictive rental index, derived using a regression model, wherein the regression model utilizes at least one parameter selected from:
a statistical historical sale of each rental property within the geological grid;
at least one statistical historical transaction of each rental property of at least one adjacent geological grid; and
a rental value of each geospatial properties of the geological grid; and
a microprocessor coupled to the non-transitory storage device, executing the set of routines to:
acquire the dwelling input from the computing device;
analyse the property database to determine an initial rent estimate (IRE) based on each property located in the geological grid and each adjacent geological grid, wherein a rental value contribution of each property is inversely proportional to a
distance from the property location;
identify the multiple comparable properties based on:
the acquired dwelling input;
at least one filter selected from: a spatial filter, a temporal filter, a configuration filter and a variance filter; and
the determined IRE;
calculate the FRE based on a rental value of the identified multiple comparable properties, wherein a rental value contribution of each comparable property is inversely proportional to a distance from the property location; and
display at the computing device, the calculated FRE.

2: The system of claim 1, wherein the microprocessor identifies a pre-set number of the comparable properties.

3: The system of claim 1, wherein the microprocessor calculates a data confidence score for the estimated FRE.

4: The system of claim 1, wherein the remote server enables the user to export a selected number of the comparable properties and the associated data, which are selected from a property information, a neighbourhood information, a zoning information, a map information, at least one image of the property and at least one street view photo of the property.

5: The system of claim 1, wherein the remote server generates a graphical representation comprising a comprehensive land history and a land improvement value, corresponding to each of the comparable property.

6: The system of claim 1, wherein the remote server enables the user to generate a custom report.

7: The system of claim 6, wherein the remote server enables the user to integrate a digital signature into the generated custom report.

8: The system of claim 1, wherein the remote server enables auto-filling of the address data based on the received property location.

9: The system of claim 1, wherein the remote server integrates with a map to provide a navigation path for each comparable property.

10: The system of claim 1, wherein the remote server receives an updation input from an authenticated user to update the property database.

11: The system of claim 1, wherein the remote server uses an encryption technique to ensure confidentiality of the dwelling input and the generated data.

12: The system of claim 1, wherein the comparable properties are sorted based on the at least one sorting keys selected from a nominal distance, a difference of year built, a difference in the number of bedrooms and a listing age.

13: A method for estimating a final rent estimate (FRE) of a property, wherein the method comprising:
receiving, at a computing device, a dwelling input from a user, wherein the dwelling input comprises a property address, the number of bedrooms, and a type of dwelling; and
acquiring, at a remote server, the dwelling input from the computing device;
analysing, a property database to determine an initial rent estimate (IRE) based on each property located in a geological grid and each adjacent geological grid, wherein a rental value contribution of each property is inversely proportional to a distance from the property location;
identifying, the multiple comparable properties based on:
the acquired dwelling input;
at least one filter selected from: a spatial filter, a temporal filter, a configuration filter and a variance filter; and
the determined RE;
calculating, the FRE based on a rental value of the identified multiple comparable properties, wherein a rental value contribution of each comparable property is inversely proportional to a distance from the property location; and
displaying at the computing device, the calculated FRE.

14: The method of claim 13, wherein the dwelling input further includes a parameter selected from a list comprising: a number of bedrooms, a number of bathrooms, an available one or more amenities, a parking facility, and an interior finishing status.

15: The method of claim 13, wherein the remote server generates a detailed report comprising a breakdown of the property features contributing to the estimation of the FRE.

16: The method of claim 13, wherein the comparable properties are sorted based on the at least one sorting keys selected from a nominal distance, a difference of year built, a difference in the number of bedrooms and a listing age.

17: The method of claim 13, wherein the remote server deploys a predictive analytics feature that estimates a future rent market value based on the current and historical market trends.

18: A computer-readable medium having stored thereon a plurality of instructions, the plurality of instructions when executed by a computing device, cause the computing device to perform operations for estimating a final rent estimate (FRE) of a property, the operations comprising:
receiving, at a computing device, a dwelling input from a user, wherein the dwelling input comprises: a property address, the number of bedrooms, and a type of dwelling; and
acquiring, at a remote server, the dwelling input from the computing device;
analysing, a property database to determine an initial rent estimate (IRE) based on each property located in a geological grid and each adjacent geological grid, wherein a rental value contribution of each property is inversely proportional to a distance from the property location;
identifying, the multiple comparable properties based on at least one from:
the acquired dwelling input;
at least one filter selected from: a spatial filter, a temporal filter, a configuration filter and a variance filter; and
the determined IRE;
calculating, the FRE based on a rental value of the identified multiple comparable properties, wherein a rental value contribution of each comparable property is inversely proportional to a distance from the property location; and
displaying at the computing device, the calculated FRE.
